(19) United States
(12) Patent Application Publication
(10) Pub. No.: US 2015/0138292 A1
(43) Pub. Date: May 21, 2015

(54) SYSTEM FOR ALIGNING A MEDIA WEB IN A PRINTING PRESS

(71) Applicant: Mark Andy, Inc., Chesterfield, MO (US)

(72) Inventor: Brian Keith Jones, Wildwood, MO (US)

(21) Appl. No.: 14/519,969

(22) Filed: Oct. 21, 2014

Related U.S. Application Data
(60) Provisional application No. 61/893,764, filed on Oct. 21, 2013.

(51) Int. Cl. B41J 11/20

(52) U.S. Cl. CPC B41J 11/20
USPC 347/104

(57) ABSTRACT

A printing system includes a media transport system configured to transport a web of print media through a printing zone in a transport direction proceeding from an up-web location to a down-web location. A plurality of printheads each at least partially span the print zone along a transverse direction which is generally orthogonal to the transport direction. A media alignment detection system is positioned down-web from the media print zone generates a signal indicative of the alignment of the web of print media along the transverse direction. A transverse adjustment mechanism positioned up-web from the media print zone, the transverse adjustment mechanism is configured to enable the adjustment of the transverse position of the web of print media based upon the signal.

### CROSS-REFERENCE TO RELATED APPLICATIONS

This application claims priority to U.S. Provisional Patent Application Ser. No. 61/893,764 filed Oct. 21, 2013. The entire disclosure of the above application is incorporated herein by reference.

### FIELD OF THE INVENTION

The present invention relates to digital commercial or industrial printing system utilizing printheads to eject dot matrix patterns of ink drops upon a web of print media to form images and text. More particularly the present invention relates to a way of aligning the web of print media in a direction that is transverse to a direction of print media transport.

### BACKGROUND

A rapid change is occurring in the commercial and industrial printing marketplace with an expanded use of digital printing presses to replace their analog counterparts. Digital printing presses have an advantage of lower “set-up” costs in that a change to a print pattern is accomplished with a file change. This improves the economics of “short run” printing and reducing a need to print large inventories of a given design.

One common form of digital printing press is a web press based upon inkjet printing of radiation curable inks. In this type of press a roll of media is unwound and then passed through a paper path defined by a series of rollers along a media transport direction. A part of the paper path is a print zone within which inkjet printheads eject a dot matrix pattern of fluid drops on a surface of the media thereby forming images and/or text on the media surface. These inkjet printheads span at least a portion of the print media along a transverse or cross-web direction that is generally orthogonal to the media transport direction.

Often there is a need to perform various other processes on the print media before the aforementioned inkjet printing. Such processes can include preliminary printing using an analog press. This may be desirable when there is a substantial portion of the printed image that does not change for a large number of impressions. Thus, the web of print media passes through a first unit (e.g., an analog printing press) before directly passing into the digital press.

One challenge with such an arrangement is the alignment of the print media within the digital press. The transition from one machine to another may result in an offset that is large enough that the inkjet printheads are not sufficiently aligned to the web of media in the transverse direction.

### DRAWINGS

The drawings described herein are for illustrative purposes only of selected embodiments and not all possible implementations, and are not intended to limit the scope of the present disclosure.

FIG. 1 is an isometric view of an exemplary printing system.

FIG. 2 is a side view of an exemplary printing system.

FIG. 3A is a plan view of a printing system 2 illustrating an automated system for aligning a print media web.

FIG. 3B is a plan view of a printing system 2 illustrating a manual system for aligning a print media web.

Corresponding reference numerals indicate corresponding parts throughout the several views of the drawings.

### DETAILED DESCRIPTION

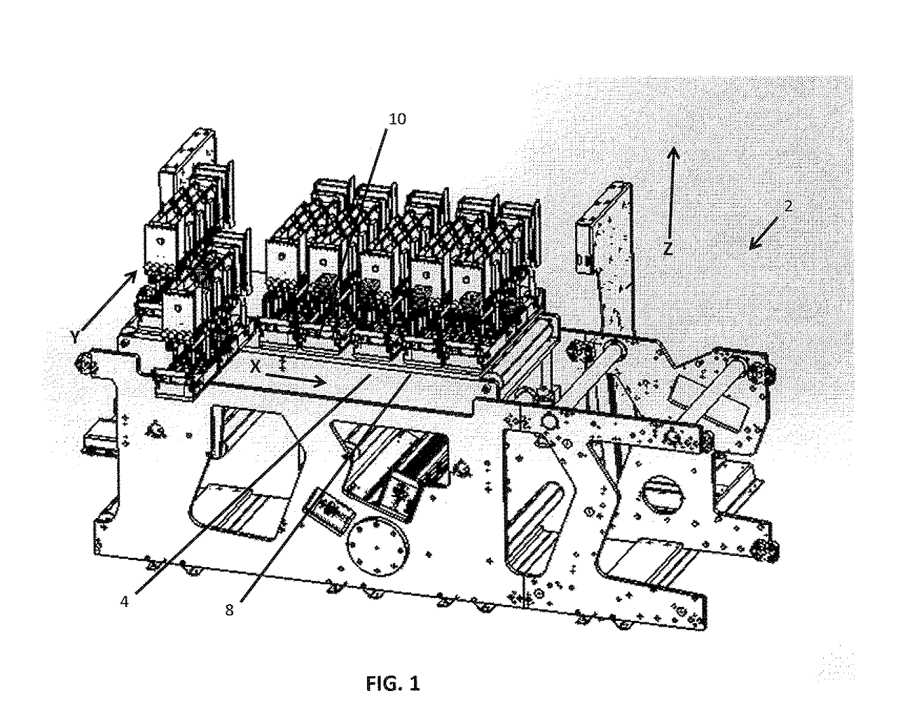

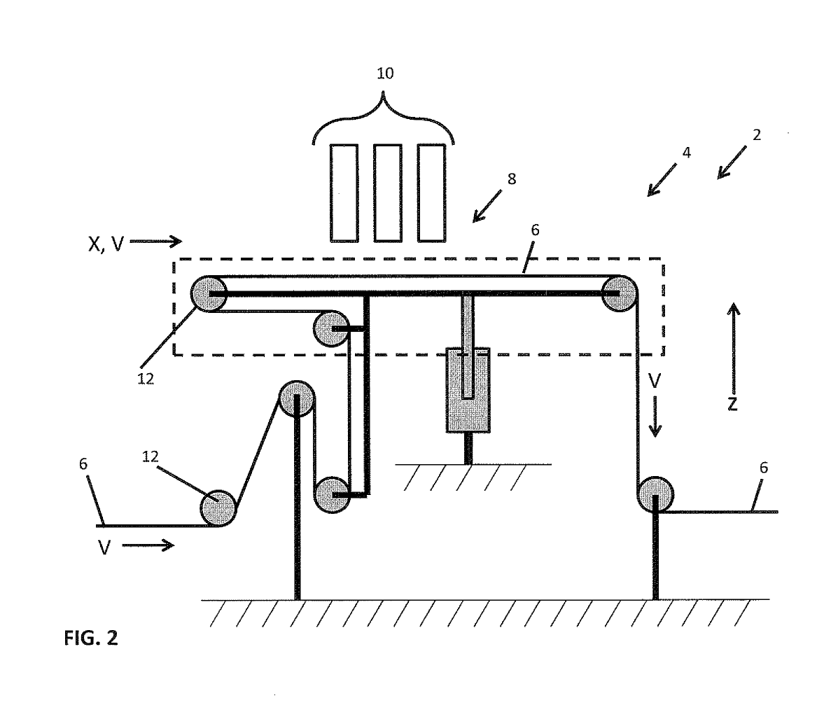

FIG. 1 is an isometric view of an exemplary embodiment of a commercial or industrial printing system 2. The printing system 2 includes a media transport system 4 configured to transport a web of print media 6 (see FIG. 2) from a source of print media (not shown) which may be an analog printing press and through a print zone 8. Within print zone 8 the print media is transported in a media transport direction X. The printheads each at least partially span the print media 6 along a transverse or cross-web direction Y. Each printhead 10 ejects droplets upon the media along a (preferably vertical) axis Z.

FIG. 2 is a side view of an exemplary printing system 2 depicting a geometric arrangement of printing system components. Media transport system 4 transports a web of print media 6 through the print zone 8 utilizing a series of rollers 12. The media moves along a circuitous media path along a media transport direction V which varies in direction with respect to X and Z. The direction V coincides with the direction X across print zone 8 over which V has no Z-component. A “down-web” direction refers to a direction of media transport. An “up-web” direction is opposite to down-web direction.

The printing system 2 includes a print zone 8 within which the printheads 10 at least partially span the print media along the transverse direction Y (into and out of the page in this view). The alignment of the print media 6 relative to the printheads 10 along Y is necessary to assure that printheads 10 can fully address the full cross-web width of print media 6.

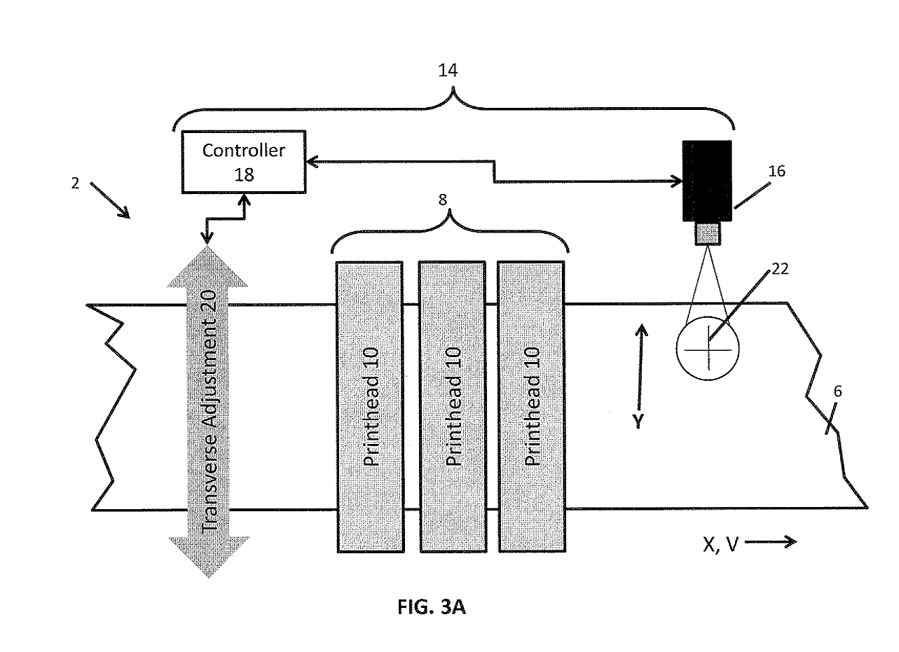

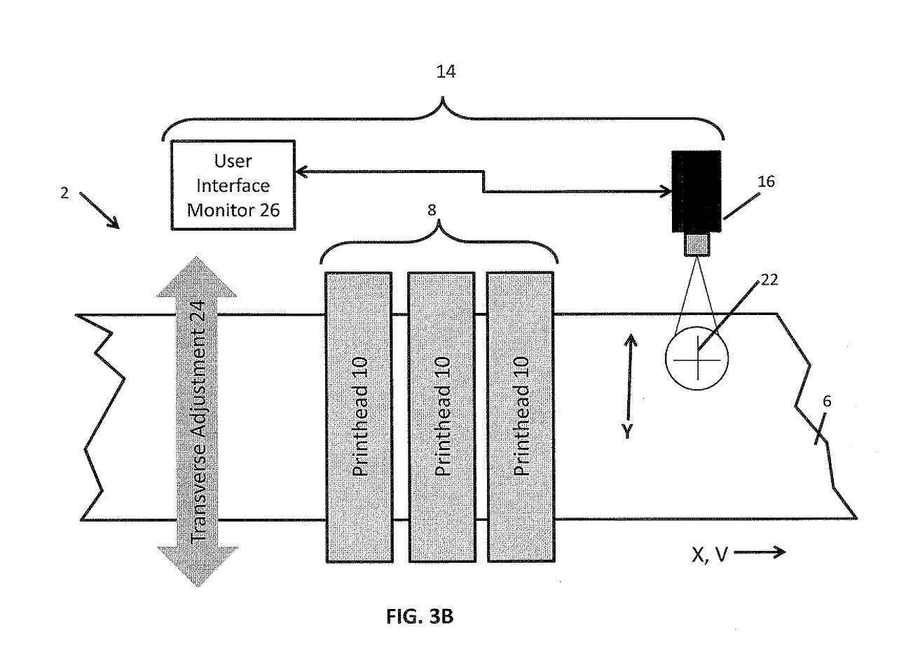

FIG. 3A is a plan view of an exemplary printing system 2 depicting a first embodiment of a system 14 for aligning the print media web 6 to the print zone 8. The system 14 includes a media alignment detection system 16 that is electrically coupled to a controller 18. A transverse adjustment mechanism 20 is under control of the controller 18. In one embodiment the transverse adjustment mechanism 20 includes a motorized lead screw that adjusts a transverse position of a portion of the media transport system 4.

In one embodiment the detection system 16 includes a camera that captures a target 22 which has been printed upon media 16 by printheads 10. Alternatively detection system 16 may include an optical detector that monitors the location of an edge of print media 6. The controller compares a location of target 22 (or alternatively some other feature such as the edge of the print media) against an expected location and controls the transverse adjustment mechanism 20 to bring the media web into proper alignment along transverse axis Y.

FIG. 3B is a plan view of an exemplary printing system 2 depicting a second embodiment of a system 14 for aligning the print media web 6 to the print zone 8. The system 14 includes media alignment monitoring system 16 that is electrically connected to user interface monitor 26. In one embodiment the coupling between monitor 26 and system 16 is wired; in another embodiment the user interface monitory receives a wireless signal from the media alignment monitoring system 16.

The media alignment monitoring system 16 may include a camera 16 that captures an image of an alignment target 22 that is printed upon the media web 6. Alternatively media alignment monitoring system may include an optical sensor that senses the position of an edge of print media 6.

A user interface monitor 26 receives a signal or image from the media alignment monitoring system 16. The user interface monitor 26 provides a visual indicator to a user of an alignment and/or misalignment of the media 6. The user may then utilize transverse adjustment mechanism 24 to adjust the alignment of the media web along axis Y. In one embodiment mechanism 24 includes a lead screw that is coupled to a portion of media transport system 4.

Further areas of applicability will become apparent from the description provided herein. The description and specific examples in this summary are intended for purposes of illustration only and are not intended to limit the scope of the present disclosure.

What is claimed is:

1. A printing system comprising:
a media transport system configured to transport a web of print media through a printing zone in a transport direction proceeding from an up-web location to a down-web location;
a plurality of printheads each at least partially spanning the print zone along a transverse direction which is generally orthogonal to the transport direction;
a media alignment detection system positioned down-web from the media print zone, the media alignment detection system configured to generate a signal indicative of the alignment of the web of print media along the transverse direction; and
a transverse adjustment mechanism positioned up-web from the media print zone, the transverse adjustment mechanism is configured to enable the adjustment of the transverse position of the web of print media based upon the signal.

2. The printing system of claim 1 further comprising a controller configured to receive the signal and to automatically control the transverse adjustment mechanism to adjust the transverse position of the media web.

3. The printing system of claim 1 further comprising a monitor configured to display a representation of a transverse misalignment of the web of print media whereby an operator can utilize the transverse adjustment mechanism to manually align the web of print media.
